(19) United States
(12) Patent Application Publication
(10) Pub. No.: US 2026/0197301 A1
(43) Pub. Date: Jul. 9, 2026

(54) APPARATUS AND METHODS FOR IMPLEMENTING SECURE FRAME-BASED COMMUNICATION

(71) Applicant: Renesas Electronics Corporation, Tokyo (JP)

(72) Inventors: Dennis OSTERMANN, Dusseldorf (DE); Christian MARDMÖLLER, Dusseldorf (DE)

(21) Appl. No.: 19/427,718

(22) Filed: Dec. 19, 2025

(30) Foreign Application Priority Data
Jan. 8, 2025 (DE) 10 2025 100 422.6

(51) Int. Cl. H04L 9/40

(52) U.S. Cl. CPC H04L 63/0428

(57) ABSTRACT

Methods and apparatus for protecting data frames at a transmission side of a frame-based communication link are described. The apparatus includes a receiver module, a cipher suite module and a transmitter module. The receiver module receives the data frame and protection information for the data frame. The protection information specifies whether the data frame is to be protected. The receiver module transmits the data frame to the cipher suite module, if the protection information specifies that the data frame is to be protected. If the protection information specifies that the data frame is not to be protected, the receiver transmits the data frames the data frame to the transmitter module. The cipher suite module protects the data frame and transmits the protected data frame to the transmit module. The transmit module provides the data frame or the protected data frame for transmission over the frame-based communication link.

### CROSS-REFERENCE TO RELATED APPLICATIONS

The disclosure of German Patent Application No. 10 2025 100 422.6 filed on Jan. 8, 2025, including the specification, drawings and abstract is incorporated herein by reference in its entirety.

### TECHNICAL FIELD

The present disclosure relates to frame-based communication and more particular to an implementation of a security aspect for frame-based communication.

### BACKGROUND

For high-speed frame-based communication, a security aspect may be difficult to implement, as a security aspect implemented in software may be too slow for achieving the desired data rate, and a hardware implementation may not provide the desired security and flexibility, as complexity and costs have to be considered as well.

For example, for Ethernet, security on the data link level is provided by Ethernet Media Access Control Security (MACsec).

MACsec is a security protocol designed to provide secure communication over Ethernet networks by protecting data at the data link layer (Layer 2). Defined in the IEEE 802.1AE and IEEE 802.1X standard, MACsec offers critical features such as data confidentiality, integrity, and authentication. It ensures that communication between directly connected devices, like switches, routers, and end-user devices, is protected from various threats, including unauthorized access, eavesdropping, replay attacks, and data tampering.

MACsec operates by adding an integrity value and a security TAG (SecTAG) to a data frame, and by optionally encrypting the payload of the data frame at the transmitter. Further, at the receiver the data frame is verified and optionally decoded (if encryption is applied at the receiver). These techniques may prevent attackers from intercepting or altering the data being transmitted. It supports point-to-point encryption, meaning it secures data on a hop-by-hop basis across network devices, making it ideal for Local Area Networks (LANs), data center environments, enterprise networks, industrial environments and automotive environments.

To both support protected data frames frames as well as unprotected data frames IEEE 802.1AE specifies a classification of data frames (SecY model). In particular, the data frames are classified by offering dedicated ports for each type, i.e. the uncontrolled (plain) and Controlled port (MACsec). This configuration is depicted in FIG. 1A). Notably, in this model, the classification of ingress frames is simply preserved by duplication of ingress frame data in the Common port demultiplexer (receive demultiplexer). Therefore, each frame is available un-processed and processed by an implementation that strictly follows IEEE 802.1AE spec. While implementing this processing on software would be feasible, for current hardware implementations, duplication of frame data would be costly in terms of area size (additionally memory) and processing power. The IEEE 802.1AE specification however explicitly allows a deviation from duplicating the ingress data frames.

Therefore, current hardware implementations avoid the data frame duplication and instead use filtering multiplexers (bypass filter). This implementation is shown in FIG. 1B). The filtering multiplexers are usually comparing certain octets in a data frame at a selected position, (e.g. EtherType) to decide whether the data frame should bypass the cipher suite (both for ingress and egress data frames). In this implementation, no Uncontrolled port is available. Therefore, the information whether a data frame belongs to a controlled or uncontrolled port is lost. To recover information on the correct port, the bypass filter needs to be “rebuilt” in upper-layer. In other words, through the bypass filter, both verified frames by the cipher suite and unprotected frames are processed by the controlled port, and the bypass filter is replicated in software to be able to distinguish between verified frames (data frames that have been protected) and unprotected data frames.

Further, two key concepts in MACsec are used to protect data frames, namely Secure Channel (SC) and Secure Association (SA).

An SC is a logical connection established between two or more MACsec-enabled devices, typically peers like switches or hosts, over which secure communication occurs. The SC forms the foundation of MACsec's security model by ensuring that all communication between devices is protected under the same security policy. Within an SC, Ethernet frames are protected using encryption and integrity checks, making eavesdropping or tampering difficult.

A single SC can have multiple SAs, which manage the actual cryptographic operations. Therefore, a SA is responsible for the cryptographic parameters (like encryption keys and algorithms) used within a SC to protect Ethernet frames.

For simplicity, it will mostly be referred to SCs in the following description, even if the functionality refers to the corresponding SA of that SC.

In the case of supporting multiple SCs, a SC selection filter may be needed additionally to recovers the multiple controlled port concept defined by IEEE 802.1AE.

In conclusion, while an implementation of the strict IEEE 802.1AE SecY model may be possible in software, high interface speeds of 1 Gbit/s and higher may not be achievable with this implementation. Further, the present relaxed hardware implementation may be suitable for scenarios with only one SC per direction and nearly all traffic being protected (i.e., consisting of protected data frames). However, the present hardware implementation may have the following limitations:
MACsec function requires consistent configuration of bypass filters in whole network
Software stack needs adaption to deal with hardware specific IEEE model deviations, i.e., the controlled port and the uncontrolled port need to be rebuilt in the software stack by copying the configurations of the bypass filter
The SC relation is lost (e.g. end-to-end MACsec), the indirect rebuild can reduce security level
   Thus, there is a need for providing an efficient hardware implementation of MACsec that overcomes the shortcomings of the current hardware implementation, while still allowing high interface speeds.

### SUMMARY

In view of the above, the present disclosure provides methods, apparatus and systems for improving security and efficiency of a frame-based communication system handling both protected and unprotected data frames, by adapting the transmission side or/and the receiving side of the frame-based communication link.

According to a first aspect of the disclosure, an apparatus for protecting a data frame for a frame-based communication link is disclosed. The apparatus may include a receiver module, a cipher suite module and a transmitter module. The receiver module may be configured to receive the data frame and protection information for the data frame. The protection information may specify whether the data frame is to be protected. The data frame and the protection information may be received from an upstream device or module of the transmitter side of the frame-based communication link. The receiver module may be further configured to transmit the data frame to the cipher suite module, if the protection information specifies that the data frame is to be protected. If the protection information specifies that the data frame is not to be protected, the receiver module may be further configured to transmit the data frame to the transmitter module, i.e., the receiver module may bypass the cipher suite module. The cipher suite module may be configured to protect the data frame and transmit the protected data frame to the transmit module. Protecting the data frame may include adding an integrity value to the data frame using the data frame and a cryptographic key. Protecting the data frame may further include encrypting the data frame based on the cryptographic key. Encrypting the data frame may include encrypting a data part of the data frame. The transmit module may be configured to provide the data frame or the protected data frame for transmission over the frame-based communication link.

By receiving explicit protection information, the apparatus for protecting the data frame is able to efficiently process the data frame, i.e., to avoid any complex filter settings for bypassing the cipher suite module in the apparatus.

In some embodiments, the protection information may be included by the data frame or the protection information is transmitted on a side-band signal. In particular, the protection information may be included in a header of the data frame. Further, the side-band signal may be a side-band signal used for transmitting auxiliary data inside and optionally outside of the apparatus.

In some embodiments, the protection information may indicate a source configuration of the data frame. In particular, data frames which are intended to be protected and data frames which should not be protected may be processed based on different source configurations. Therefore, the protection information may indicate information about the data origin, which may be any one of a dedicated DMA channel, other channel configuration and forwarding information from a preprocessing switch or router.

In some embodiments, the protection information may further specify a security channel, SC, associated with the data frame, if the protection information specifies that the data frame is to be protected. In this case, the receiver module may be further configured to transmit the protection information to the cipher suite module. Protecting the data frame may be based on the SC.

In some embodiments, the frame-based communication link may be a wired communication link. In particular, the frame-based communication link may be an Ethernet communication link and the apparatus may be a Media Access Control Security, MACsec apparatus of a transmission Ethernet side. Therefore, the data frame may be an Ethernet data frame.

In some embodiments, the protected data frame may be provided to an Ethernet MAC module. The apparatus may include the Ethernet MAC module or the Ethernet MAC module may be connected to the apparatus.

In some embodiments, the protection information may be removed before transmitting the data frame over the frame-based communication link.

According to a second aspect of the disclosure, a transmission side device of a frame-based communication link is provided. The transmission side device may include the apparatus for protecting data frames according to any embodiment of the first aspect. The transmission side device may further include a data frame source. The data frame source may be configured to provide the data frame to the apparatus based on the source configuration of the data frame, to generate the protection information based on the source configuration of the data frame, and to provide the protection information to the apparatus.

In some embodiments, the transmission side device may be a client device and the data frame source may be a frame generation software stack of the client device, or the transmission side device may be a network switch and the data frame source may be a forwarding module in the network switch.

According to a third aspect of the disclosure, an apparatus for verifying a data frame for a frame-based communication link is provided. The apparatus may include a receiver module, a cipher suite module and a transmitter module. The receiver module may be configured to receive the data frame and to generate protection information based on content of the data frame, wherein the protection information specifies whether the data frame has been protected. The data frame may be received from an upstream module or device of the receiving side of the frame-based communication link. Generating the protection information based on the content of the data frame may include reading a header of the data frame and generating the protection information based on the header of the data frame. The receiver module may be further configured to transmit the data frame and the protection information to the cipher suite module, if the content of the data frame indicates that the data frame has been protected. If the content of the data frame indicates that the data frame has not been protected, the receiver module may be further configured to transmit the data frame and the protection information to the transmitter module, i.e., bypassing the cipher suite module. The cipher suite module may be configured to verify the data frame and to transmit the verified data frame and the protection information to the transmit module. The transmit module may be configured to provide the protection information and the data frame or the verified data frame for further processing by a data frame destination of the frame-based communication link.

In the prior art, any protection information may be lost after a data frame is verified. By providing the protection information to a downstream module or device (e.g., the data frame destination) of receiver side of the frame-based communication link, the protection information can be used to efficiently process the data frame at the destination, e.g., to separate data frames that had been protected from data frames that had not been protected.

In some embodiments, the protection information may be included by the data frame or the protection information is transmitted on a side-band signal. In particular, the protection information may be included in a header of the data frame. Further, the side-band signal may be a side-band signal used for transmitting auxiliary data inside and optionally outside of the apparatus.

In some embodiments, the protection information may indicate a destination configuration of the data frame. In particular, data frames which have been protected and data frames which have not been protected may be processed based on different destination configurations. Therefore, the protection information may indicate this configuration. The destination configuration of the data frame may be any one of a direct memory access controller, DMAC, channel, a channel configuration of a DMAC channel, and a forwarding configuration.

In some embodiments, the cipher suite module may be further configured to decrypt the data frame, i.e., if the data frame has been encrypted. In particular, cipher suite module may be configured to decrypt a data part of the data frame.

In some embodiments, the cipher suite module may be further configured to determine a type of validation error (e.g., as specified in IEEE), if the verification of the data frame returns a negative result. In this case, the cipher suite module may be further configured to add the type of validation error to the protection information and to transmit the protection information and the negatively verified data frame to the transmission module. Further, the transmission module may be further configured to provide the negatively verified data frame and the protection information for further processing by the data frame destination of the frame-based communication link.

Thereby, a debugging or intrusion analysis may be enabled for the data frame destination based on the protection information and the data frame.

In some embodiments, the protection information may further specify a security channel, SC, associated with the data frame, if the protection information specifies that the data frame has been protected. In particular, the receiving module may be configured to determine the SC based on a header of the data frame. Verifying the data frame may be based on the SC.

In some embodiments, the frame-based communication link may be a wired communication link. In particular, the frame-based communication link may be an Ethernet communication link and the apparatus may be a Media Access Control Security, MACsec apparatus of a receiving Ethernet side. Therefore, the data frame may be an Ethernet data frame. The data frame may be received from an Ethernet MAC module. The apparatus may include the Ethernet MAC module or the Ethernet MAC module may be connected to the apparatus.

According to a fourth aspect of the disclosure, a receiving side device of a frame-based communication link is provided. The receiver device may include an apparatus for verifying a data frame according to any embodiment of the third aspect. The receiver device may further include a data frame destination. The data frame destination may be configured to receive the data frame from the apparatus and to process the data frame based on the protection information.

In some embodiments, the receiving side device may be a client device and the data frame destination may be a frame receiving software stack of the client device or the receiving side device may be a network switch and the data frame destination may be a forwarding module in the network switch.

In some embodiments, the processing by the data frame destination may include a validation error analysis based on the type of the validation error, if the data frame is a negatively verified data frame, i.e., if the apparatus for verifying the data frame negatively verifies the data frame and adds the type of validation error to the protection information.

According to a fifth aspect of the disclosure, a method for protecting a data frame for a frame-based communication link is disclosed. The method may implement the functionalities defined according to any variation of the first aspect.

According to a sixth aspect of the disclosure, a method for verifying a data frame for a frame-based communication link is provided. The method may implement the functionalities defined according to any variation of the third aspect.

In some embodiments, the method according to the fifth aspect may be used in addition to the method for verifying a data frame for a frame-based communication link.

According to a seventh aspect, a system for a frame-based communication link is provided. The system includes the apparatus according to any variation of the first aspect on the transmission side of the frame-based communication link and the apparatus according to any variation of the third aspect on the receiving side of the frame-based communication link.

According to an eights aspect, a system for a frame-based communication link is provided. The system includes a transmitter side device according to any variation of the second aspect and a receiver side device according to any variation of the fourth aspect.

It will be appreciated that apparatus features and method steps may be interchanged in many ways. In particular, the details of the disclosed method(s) can be realized by the corresponding apparatus (or system), and vice versa, as the skilled person will appreciate. Moreover, any of the above statements made with respect to the method(s) are understood to likewise apply to the corresponding apparatus (or system), and vice versa.

### BRIEF DESCRIPTION OF DRAWINGS

Example embodiments of the disclosure are explained below with reference to the accompanying drawings, wherein

FIG. 1A illustrates the SecY architecture defined by IEEE 802.1AE,

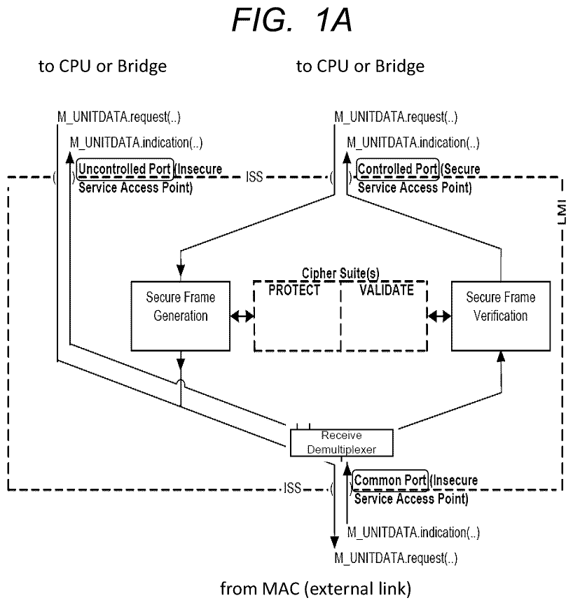

FIG. 1B schematically illustrates a relaxed hardware implementation of the SecY architecture deviating from the specification in IEEE 802.1AE,

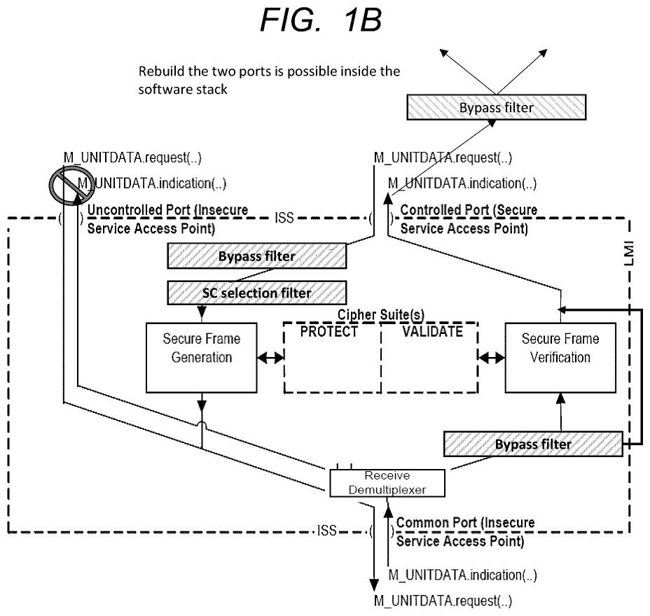

FIG. 2 schematically illustrates an apparatus for protecting frames at a transmission side of a frame-based communication link according to embodiments of the disclosure,

FIG. 3 schematically illustrates a transmission side device of a frame-based communication link according to embodiments of the disclosure,

FIGS. 4A, 4B, 4C schematically illustrate an apparatus for protecting frames at a transmission side of an Ethernet system according to the prior art FIGS. 4A and 4B) and according to embodiments of the disclosure FIG. 4C)),

FIG. 5 schematically illustrates a transmission side device of an Ethernet system according to embodiments of the disclosure,

FIG. 6 schematically illustrates an apparatus for verifying frames at a receiving side of a frame-based communication link according to embodiments of the disclosure,

FIG. 7 schematically illustrates a receiving side device of a frame-based communication link according to embodiments of the disclosure,

FIGS. 8A, 8B, 8C schematically illustrate an apparatus for protecting frames at a transmission side of an Ethernet system according to the prior art FIGS. 8A and 8B) and according to embodiments of the disclosure FIG. C),

FIG. 9 schematically illustrates a receiving side device of an Ethernet system according to embodiments of the disclosure,

FIG. 10 is a flowchart illustrating an example of a method of protecting frames at a transmission side of a frame-based communication link according to embodiments of the disclosure,

FIG. 11 is a flowchart illustrating an example of a method of verifying data frames for a frame-based communication link according to embodiments of the disclosure, and

FIG. 12 depicts a Packet Control Header (PCH) format according to USXGMII.

FIG. 13 is a table for defining 9 states for a negative verification for an Ethernet System.

FIG. 14 is a table for listing a format according to the internal descriptor format of the RSwitch2.

FIG. 15 is a table for showing an example USXGMII PCH format extended by the MACSec classifer.

### DETAILED DESCRIPTION

To provide an enhanced hardware implementation of the SecY model, the transmission part as well as the receiving part of the SecY model may need adaptation. In addition, other parts of the Ethernet system (other than the MACsec module) may need to be changed to achieve these improvements. While the invention for the transmitting side and the receiving side of a frame-based communication link will be mostly presented with reference to the Ethernet standard, it is noted that the invention may be implemented for any frame-based communication link with a layer 2 security system.

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed. Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

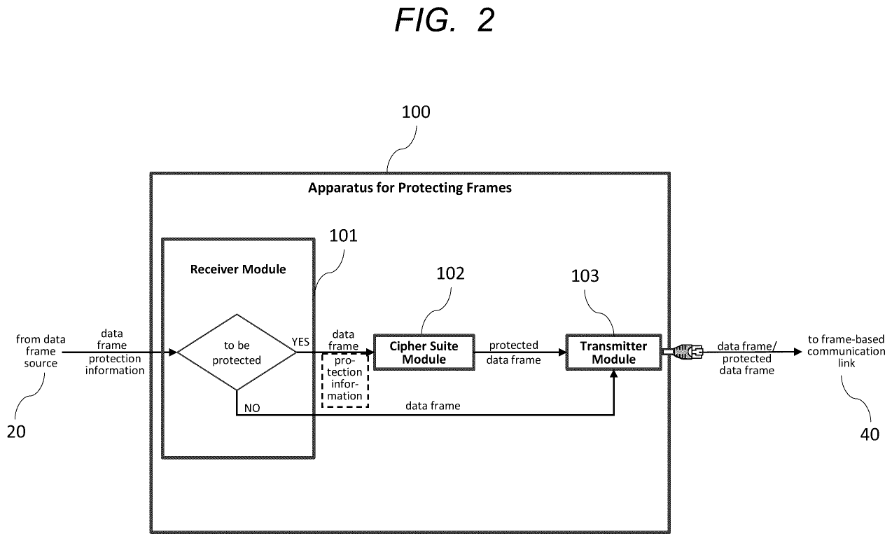

FIG. 2 schematically illustrates an apparatus 100 for protecting data frames at a transmission side of a frame-based communication link.

Apparatus 100 comprises three modules, namely a receiver module 101, a cipher suite module 102 for protecting data frames, and a transmitter module 103. The receiver module 101 is configured to receive the data frames. The data frame may be received from an upstream module/apparatus of the transmission side of the frame-based communication link. Upstream apparatus and apparatus 100 may be part of a single physical device or may be separate physical devices and connected, e.g. via cable. In addition to the data frame itself, receiving module 101 may be further configured to receive protection information. The protection information specifies whether a data frame is to be protected by cipher suite module 102 or not, i.e., should bypass cipher suite module 102. The protection information may be appended to the data frame itself, e.g., in a header part of the data frame, or may be transported on a side band link. Notably, the protection information may explicitly classify the data frames as ‘U’ (un-controlled) or ‘C’ (controlled) for specifying a data frame not to be protected and a data frame to be protected, respectively. The classification may be performed by hardware of the transmit side of the frame-based communication link, e.g., by a data frame source 20. As an example, a Direct Memory Access Controller (DMAC) of the transmit side of the frame-based communication link may use dedicated channels for controlled and un-controlled data frames. Therefore, the protection information may indicate a data frame source configuration. Other examples of the data frame source configuration may be different configurations of a DMAC channel, for example, if the DMAC uses a single channel configuration. If data frames are routed via a network switch of the frame-based communication link, the data frame source configuration may be a forwarding configuration of the network switch.

After receiving both the data frame and the protection information, the receiver module 101 is configured to transmit/provide the data frame to cipher suite module 102, if the protection information specifies that the data frame is to be protected. Otherwise, the receiver module 101 is configured to transmit/provide the data frame directly to the transmitter module 103, i.e., to an output of apparatus 100.

If the frame-based communication link uses multiple SCs, the protection information may additionally specify an SC for a data frame that is to be protected. In this case, the receiver module may additionally transmit/provide the protection information to the cipher suite module 102.

Cipher suite module 102 is configured to protect the data frame. Protecting the data frame may include generating an integrity value based on the content of the data frame and a cryptographic key. The integrity value may then be added to the data frame by cipher suite module 102 to generate a protected data frame. The integrity value may enable a receiving side to authenticate whether the content of the data frame has been altered, by generating a second integrity value based on the content of the data frame and the same cryptographic key that has been used at the transmission side, and by comparing the integrity value included in the data frame to the generated second integrity value.

Protecting the data frame may further comprise encrypting the data frame based on the cryptographic key. More precisely, a payload of the data frame may be encrypted. If the frame-based communication link uses multiple SCs, the cryptographic key may be chosen based on the SC, i.e., by reading the protection information transmitted/provided by receiver module 101.

Then, cipher suite module 102 transmits/provides the protected data frame to transmitter module 103, i.e., the output of the apparatus.

Transmitter module 103 is configured to provide the data frame or the protected data frame (depending on whether the data frame has been protected by cipher suite module 102) for transmission over the frame-based communication link. In other words, transmitter module 103 may provide the (protected) data frame to a downstream apparatus 40 of the frame-based communication link. Apparatus 100 and the downstream apparatus may be part of a same physical device or may be separated devices that are electrically connected, e.g., via Media Independent Interface (MII).

By receiving and using the specific protection information, apparatus 100 can efficiently process all frame types (to be protected data frames and frames that should not be protected) without any complex filter settings (e.g., comparing certain octets in a data frame at a selected position to decide whether the frame is bypassed). In other words, in the prior art a filter may be used that investigates certain parts of the data frame (may be application specific) to decide whether a data frame should bypass protection processing. These filter configurations may need to be distributed consistently over a whole network. In contrast, apparatus 100 explicitly receives the protection information and filter the data frames based on the protection information. Therefore, the filtering operation has a low complexity and may be application and network independent.

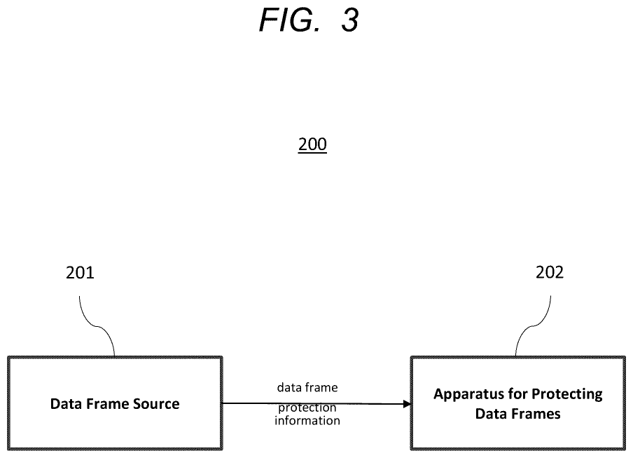

Further, in FIG. 3 a transmission side device 200 of the frame-based communication link is depicted. Transmission side device 200 comprises a data frame source 201. Data frame source 201 may generate the data frames for a frame-based communication link or may be an initial hardware processing of the data frames. For example. If transmission side device 200 is a client device, a data frame source 201 may be a software stack of the client device or the data frame source 201 may be a DMAC of the client device. If transmission side device 200 is a network switch, data frame source 201 may be a forwarding module of the network switch, i.e., a module for forwarding received data frames. The data frames may already be separated in the software stack based on protected/unprotected and based on SCs, if multiple SCs are used.

Transmission side device 200 further comprises an apparatus 202 for protecting the data frames. Apparatus 202 may be any implementation variant of apparatus 100. Data frame source 201 transmits/provides the data frame and the protection information to apparatus 202. By generating the protection information and transmitting/providing the protection information to apparatus 202, apparatus 202 can easily filter frames for bypassing a protection process, as already explained for apparatus 100.

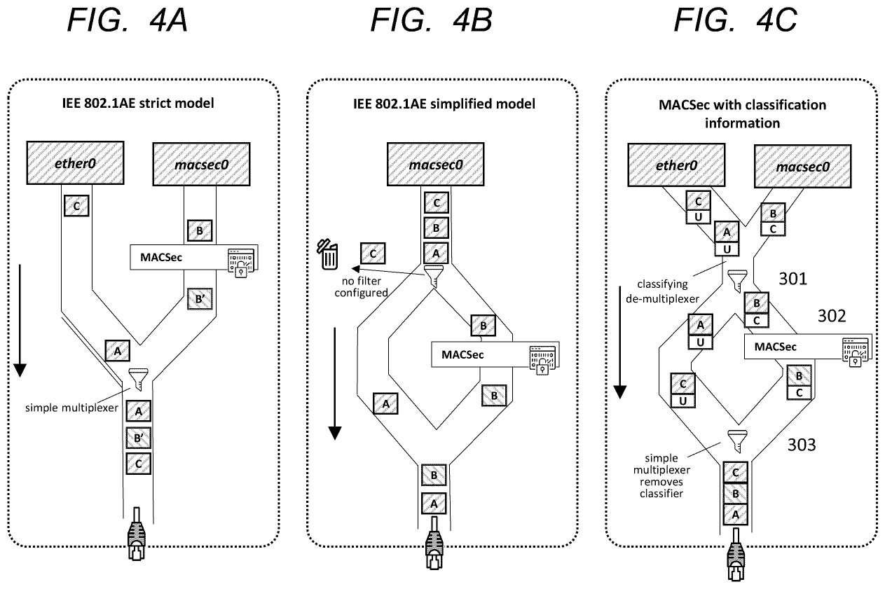

Next, FIGS. 4A to 4C depict the flow of data frames through a transmission side MACsec module according to the strict version defined in IEEE 802.1AE (current software implementation), the relaxed hardware implementation, and a MACsec module according to embodiments of the present disclosure, respectively. In particular, apparatus 300 may be an implementation of apparatus 100 in the Ethernet context. Therefore, classifying de-multiplexer 301 may be correspond to receiver module 101, MACsec module 302 may correspond to cipher suite model 102 and multiplexer 303 may correspond to transmitter module 103.

In all 3 models, unprotected frames are represented with a first hatching direction (frames A and C, and frame B before the MACSec module), while protected frames are represented with second hatching direction (frame B after the MACSec module). Further, ether0 may represent an interface of a uncontrolled port and macsec0 may represent an interface of a controlled port.

A data frame with a white square may represent a data frame with classification information (c for controlled and u for uncontrolled). The classification information may correspond to the protection information as defined for apparatus 100.

In the case of FIG. 4A no special configuration is needed for any multiplexer/de-multiplexer as the different types of data frames are separated by different ports. In contrast, in the current hardware implementation according to FIG. 4B, all types of data frames are received from a single port. Therefore, complex filter configurations are needed in order to decide whether a data frame should bypass the MACsec module. Some data frames may be dropped (data frame ‘C’), if the do not match any filter settings.

In the hardware implementation with classification information according to FIG. 4C, all data frames are either classified as ‘C’ or ‘U’ by the source of the data frames. Thereby, simple filter can be used at receiver 301, which merely has to send data frames with a ‘C’ to the MACsec module 302, and data frames with a ‘U’ directly to the multiplexer 303 (bypassing MACsec module 302). By adding the classification information/protection information either as part of the data frame or one a side band interface, an Ethernet layer 2 security module supporting both protected and unprotected traffic can be efficiently implemented in hardware. Optionally, multiplexer 303 may remove the protection information, as it no longer needed by the downstream modules/devices.

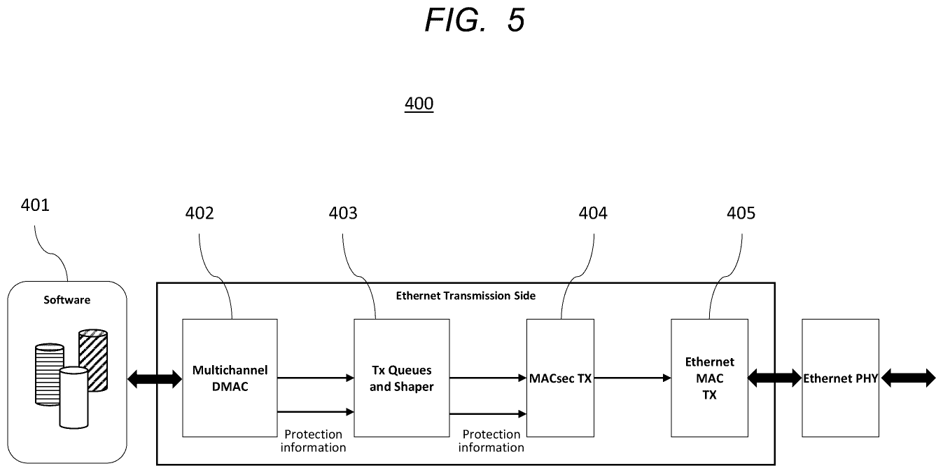

Next, FIG. 5 discloses a complete transmission side 400 of an Ethernet link according to embodiments of this disclosure. Transmission side 400 may comprise a software stack 401 that generates the data frames. Software stack 401 may be an implementation of frame data source 201 in the Ethernet context. The different types of data frames (‘C’ and ‘U’) may already be separated in software stack 401 and transported by different DMAC channels 402. Alternatively, the DMAC may use different configurations for the different types of data frames if the DMAC is single channel. In a next step, the data frames and the protection information are handed to the MACsec TX module 404 by a TX Queues and Shaper module 403 of the Ethernet transmission side. MACsec TX module 404 may be an implementation of apparatus 202 or 100 in the Ethernet context. MACsec TX module 404 provides the stream of protected and unprotected data frames to the Ethernet MAC TX 405 module for further processing.

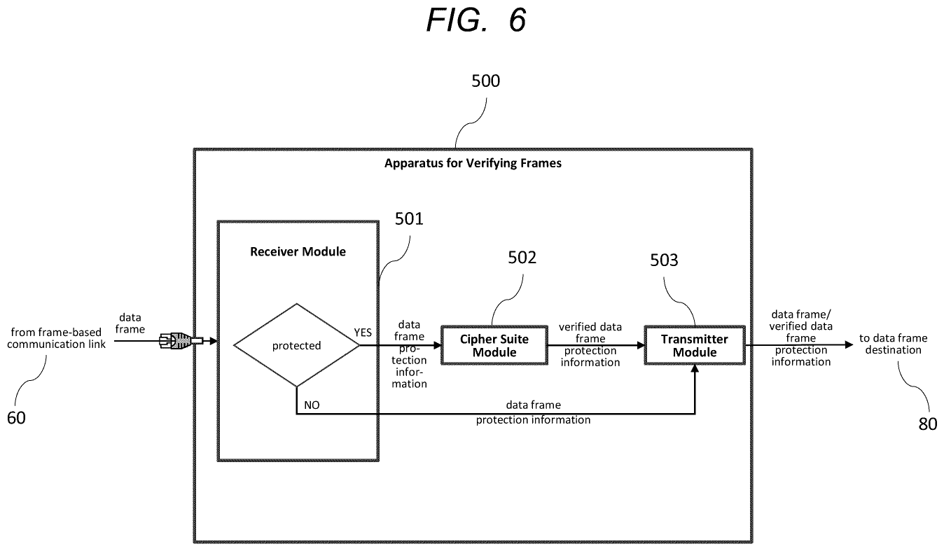

FIG. 6 schematically illustrates an apparatus 500 for protecting data frames at a receiver side of a frame-based communication link.

Apparatus 500 comprises three modules, namely a receiver module 501, a cipher suite module 502 for protecting data frames, and a transmitter module 503. The receiver module 501 is configured to receive the data frames. The data frame may be received from an upstream module/apparatus 60 of the receiver side of the frame-based communication link. Upstream apparatus and apparatus 500 may be part of a single physical device or may be separate physical devices and electrically connected, e.g. via MII.

Receiver module 501 further generates/determines protection information based on the content of the data frame. Generation based on the content of the data frame may dependent on the particular frame-based communication system. For Ethernet, for example, each protected data frame may comprise a security tag in its header. In this case, the protection information may be based on the existence of the security tag in the header of the data packet. The protection information specifies whether a data frame has been protected, e.g., by cipher suite module 102 of the transmission side of the frame-based communication link. The protection information may be appended to the data frame itself, e.g., in a header part of the data frame, or may be transported on a side band link. Notably, the protection information may explicitly classify the data frames as ‘U’ (un-controlled) or ‘C’ (controlled) for specifying a data frame that has not been protected and a data frame that has been protected, respectively.

After receiving the data frame and generating the protection information, the receiver module 501 is configured to transmit/provide the data frame and the protection information to cipher suite module 502, if the content of the data frame indicates that the data frame has been protected. Otherwise, receiver module 501 is configured to transmit/provide the data frame and the protection information directly to the transmitter module 503, i.e., to an output of apparatus 500.

If the frame-based communication link uses multiple SCs, the protection information may additionally specify an SC of a data frame that has been protected. In this case, the receiver module 501 may be further configured to determine the SC of the data frame based on the content of the data frame. For an Ethernet system for example, the SC may be determined by inspecting the security tag of the header of the data frame. Receiver module 501 may additionally transmit/provide the protection information to the cipher suite module 502. Alternatively, cipher suite module 502 may be configured to extract the SC information from the data frame and add the SC information to the protection information, as cipher suite module 502 may inspect the data frame for verification and decryption purposes.

Cipher suite module 502 is configured to verify the data frame. Verifying the data frame may include generating an integrity value based on the content of the data frame and a cryptographic key. By comparing the integrity value included in the data frame to the generated integrity value, an integrity of the data in the data frame may be verified.

Cipher suite module 502 may be further configured to decrypt the data frame based on the cryptographic key, i.e., if the data frame has been encrypted by cipher suite module 502. More precisely, a payload of the data frame may be decrypted.

If the frame-based communication link uses multiple SCs, the cryptographic key may be chosen based on the SC, i.e., by reading the content of the data frame.

Optionally, cipher suite module 502 may be configured to add additional information to the protection information based on an outcome of the verification process. In particular, if verification of the data frame fails, cipher suite module 502 may add an indication why the verification did fail to the protection information.

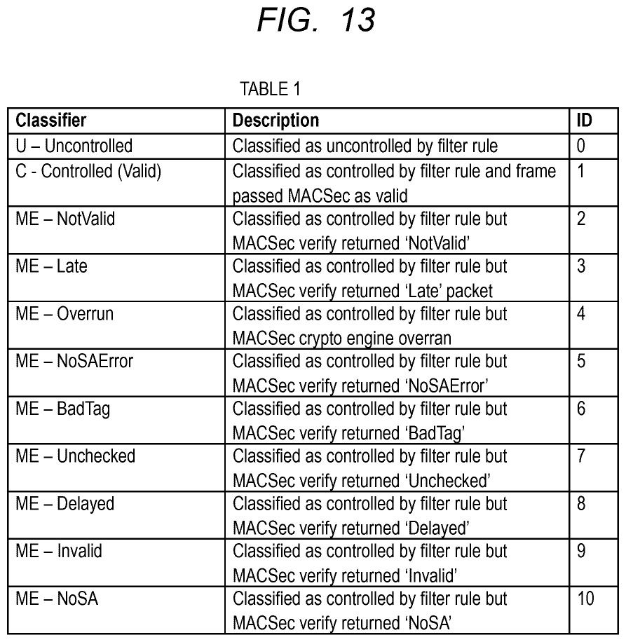

Then, cipher suite module 502 transmits/provides the verified data frame and the protection information to transmitter module 503, i.e., the output of the apparatus. For an Ethernet System, 9 states may be defined for a negative verification. These states are shown in Table 1 of FIG. 13as IDs 2 to 10. A negative verification is understood as an identification of a problem during verification that normally would lead to discarding of the data frame (IDs 2 to 6) or would not lead to discarding of the data frame (IDs 7 to 10).

Therefore, specifically for IDs 2 to 6, the data frames that would normally be discarded may now be used for error investigation (debugging), as they are forwarded together with the error information.

Further, in the case of a positive verification, cipher suite module 502 may be configured to add information indicate of the positive verification to the protection information (for Ethernet system as an example, see Table 1, ID 1). Cipher suite module 502 may be further configured to transmit/provide the negatively verified data frame to transmit module 503. Therefore, a data frame may be forwarded to transmitter module 503, irrespective of an outcome of the verification process. In contrast to a system in which negatively verified data frame are discarded, a downstream device on the reiver side of the frame-based communication link may be able to identify errors in the system and/or attacks on the system, based on the negatively verified data frame and the error information in the protection information.

Transmitter module 503 is configured to provide the data frame or the verified (and optionally decrypted) data frame and the protection information for further processing by a data frame destination 80 of the frame-based communication link. In other words, transmitter module 503 may provide the (protected) data frame to a downstream apparatus of the receiving side of the frame-based communication link. Apparatus 500 and the downstream apparatus may be part of a same physical device or may be separated devices that are connected, e.g., via cable.

In case the error information and the negatively verified data frame is forwarded to transmitter module 503 by cipher suite module 502, the error information and the negatively verified data frame may also be provided further processing by the data frame destination.

The classification may be performed by hardware of the transmit side of the frame-based communication link, e.g., by a frame data source of the frame-based communication link. As an example, a Direct Memory Access Controller (DMAC) of the transmit side of the frame-based communication link may use dedicated channels for controlled and un-controlled data frames.

The protection information may be indicative of a data frame destination configuration. As an example, a Direct Memory Access Controller (DMAC) of the receiver side of the frame-based communication link may use dedicated channels for controlled and un-controlled data frames, i.e., based on the protection information. Other examples of the data frame destination configuration may be different configurations of a DMAC channel, for example. If the DMAC uses a single channel configuration. If data frames are routed via a network switch of the frame-based communication link, the data frame destination configuration may be a forwarding configuration of the network switch.

By generating and forwarding the protection information, a downstream apparatus of apparatus 500 can recover all data related to protection of a data frame (i.e., if it has been protected, which SC had been used, whether the verification process has been positive or negative, and if negative, why it has been negative). Thereby, a complex re-classification at the data frame destination may be avoided, as all relevant information that has been available to apparatus 500 may also be available to the data frame destination. Thereby, data frames may be processed efficiently at the data frame destination. Additionally, a security aspect may be improved, as re-classification of the data frames at the data frame destination may enable different security attacks. For example, a data frame expected on a first SC, but arriving on a second SC, would be assigned to the first SC by a re-classification at the data frame destination. Therefore, an intruder may use an SC to communicate with an application (allocated to the SC) that would not be accessible without the re-classification.

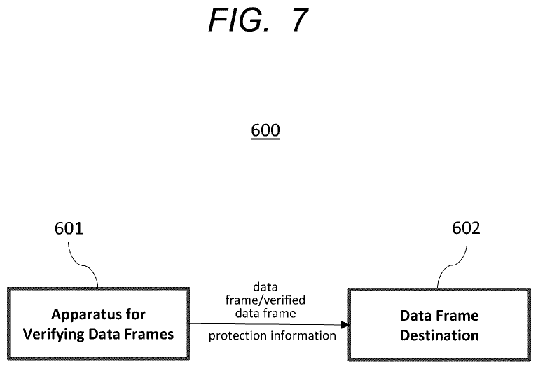

Further, in FIG. 7 a receiver side device 600 of the frame-based communication link is depicted.

Transmission side device 600 further comprises an apparatus 601 for protecting the verifying the data frames and a data frame destination 602. Apparatus 601 may be any implementation variant of apparatus 500. Apparatus 601 transmits/provides the (verified and optionally negatively verified) data frame and the protection information to data frame destination 602.

Data frame destination 602 may receive the data frames and the protection information. Data frame destination is configured to process the data frame based on the protection information For example, if receiver side device 600 is a client device, a data frame destination 602 may be a software stack of the client device or data frame destination 202 may be a DMAC of the client device. The DMAC may use different channels for the different types of data frames or a different channel configuration for the different types of data frames.

If receiver side device 600 is a network switch, data frame destination 602 may be a forwarding module of the network switch, i.e., a module for forwarding received data frames. The data frames may be separated in the software stack based on the protection information, i.e., based on whether data frames have been protected/unprotected, successfully verified or negatively verified and based on SCs, if multiple SCs are used.

By generating the protection information and transmitting/providing the protection information to data frame destination 602, data frame destination 602 can efficiently process the received data frames without any further complex re-classification, as already explained for apparatus 500.

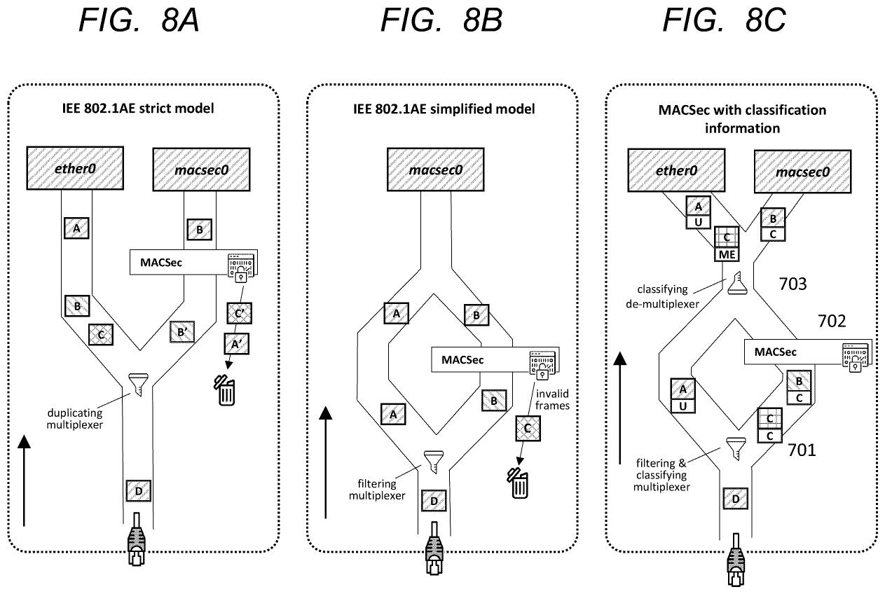

Next, FIGS. 8A to 8C depict the flow of data frames through a receiver side MACsec module according to the strict version defined in IEEE 802.1AE (current software implementation), the relaxed hardware implementation, and a MACsec module according to embodiments of the present disclosure, respectively. In particular, apparatus 700 may be an implementation of apparatus 500 in the Ethernet context. Therefore, filtering and classifying multiplexer 701 may be correspond to receiver module 501, MACsec module 702 may correspond to cipher suite model 502 and classifying and de-multiplexer 703 may correspond to transmitter module 503.

In all 3 models, unprotected frames are represented with a first hatching direction (frames A and D, and frame B after the MACSec module), while protected frames are represented with a second hatching direction (frame B before the MACSec module). Further, ether0 may represent an interface of an uncontrolled port and macsec0 may represent an interface of a controlled port.

A data frame with a white square may represent a data frame with classification information (c for controlled, u for uncontrolled and ME for a type of verification error). The classification information may correspond to the protection information as defined for apparatus 500. Further, protected data frames that are erroneous, i.e., verification of said data frames will yield a negative result, are represented by a cross-hatched pattern (frame C).

In the case of FIG. 4A no special configuration is needed for any multiplexer/de-multiplexer as the different types of data frames are duplicated and transmitted to each port. Further, unprotected frames and protected frames that are negatively verified are discarded by the MACsec module. In contrast, in the current hardware implementation according to FIG. 4B, all types of data frames are filtered to either select the MACsec module or the directly the receiving port. As in the strict implementation, negatively verified data frame are discarded by the MACsec module. As all data frames ate forwarded to a same receiving port without any further information (e.g., protected/unprotected), complex filter settings may be needed to recover this information, if possible at all. Further, in the strict implementation and the current hardware implementation, a debugging process or an analyses of a system attack may be very difficult (strict hardware implementation), or even impossible (current hardware implementation), as negatively verified data frames are discarded and no information concerning said data frames is available to the data frame destination.

In contrast, in the hardware implementation with classification information according to FIG. 4C, all data frames are either classified as ‘C’ or ‘U’ by the filtering and classifying multiplexer 701. This information is forwarded to the receiving ports, either through MACsec module 702, or by bypassing MACsec module 702. Further, MACsec module may further add information concerning the verification result, i.e., Ids 1 to 10 of Table 1 in FIG. 13. Classifying de-multiplexer 703 than can provide the data frames to the respective receiving ports for further processing based on the classification information.

By adding the classification information/protection information either as part of the data frame or one a side band interface, an Ethernet layer 2 security module supporting both protected and unprotected traffic can be efficiently implemented in hardware. Further, the data frame destination may efficiently process the data frames based on the classification information and may even be able to provide a debugging process based on the classification information.

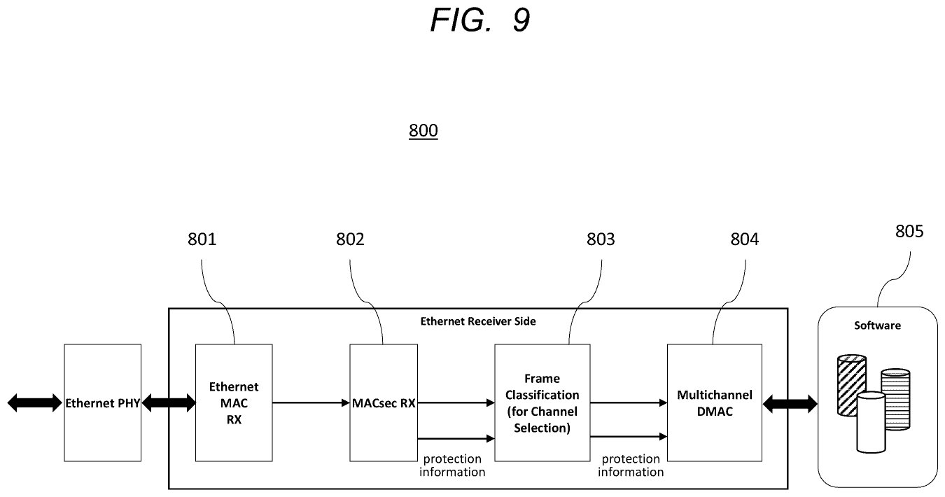

Next, FIG. 9 discloses a complete receiver side 800 of an Ethernet link according to embodiments of this disclosure. Receiver side 800 may comprise MACsec RX module 802. MACsec RX module 802 may be an implementation of apparatus 601 or 500 in the Ethernet context. MACsec RX module 802 receives the stream of protected and unprotected data frames from the Ethernet MAC RX module 801. Then MACsec RX module 802 may process the data frames (see description of apparatus 601 or 500) and generate/determine the protection information. The protection information and the data frames may be forwarded to downstream modules/devices. For a multichannel DMAC 804, the protection information is first forwarded to a frame classification module 803 for channel selection of the DMAC. If the DMAC is single channel, different channel configuration may be used based on the protection information.

Receiver side 800 may further comprise a software stack 805 that receives/processes the data frames based on the protection information. Software stack 805 may be an implementation of frame data destination 602 in the Ethernet context. As the different types of data frames are separated in software stack 805 (e.g., the DMAC may store the protection information corresponding to the different types of data frames in different Random Access Memory (RAM) regions), an efficient processing of the data frame can be implemented, and through the additional information (e.g., information on a verification error), a debugging process may be implemented.

The embodiments related to the receiver side of the frame-based communication link and the embodiments related to the transmitter side of the frame-based communication link may be used independently or may both be implemented in a frame-based communication system.

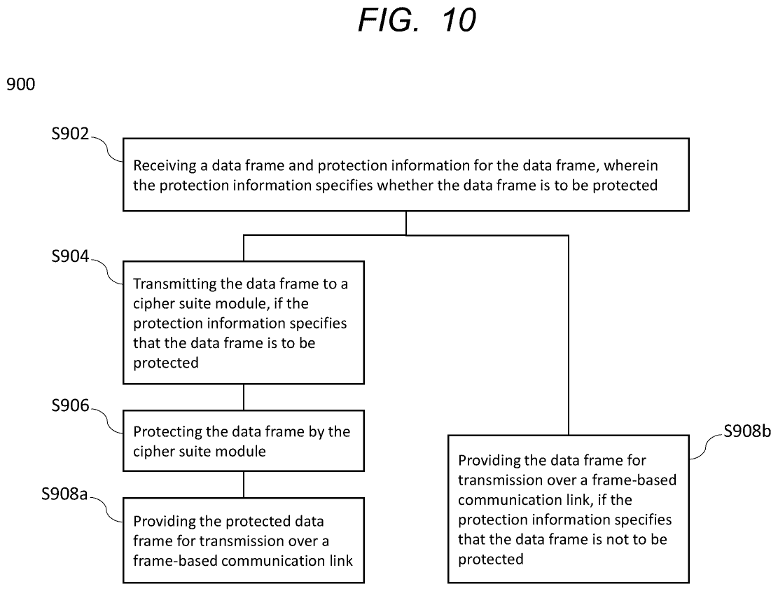

In line with the above, a method 900 is provided for protecting frames at a transmission side of a frame-based communication link as depicted in the flowchart of FIG. 10. In addition to the following method steps, method 900 may optionally include all variations described above with respect to apparatus 100, 201, 300 and 402 that have been described in connection with FIGS. 2 to 5.

In step S902, a data frame and protection information for the data frame are received, wherein the protection information specifies whether the data frame is to be protected. If the frame-based communication link uses multiple SCs, the protection information may additionally specify an SC for a data frame that is to be protected.

In step S904, the data frame is transmitted to a cipher suite module, if the protection information specifies that the data frame is to be protected.

In step S906, the data frame is protected by the cipher suite module.

In step S908a, the protected data frame is provided for transmission over a frame-based communication link.

Alternatively, in step S908b, the data frame is directly provided for transmission over a frame-based communication link (i.e., omitting steps 904 and 906), if the protection information specifies that the data frame is not to be protected.

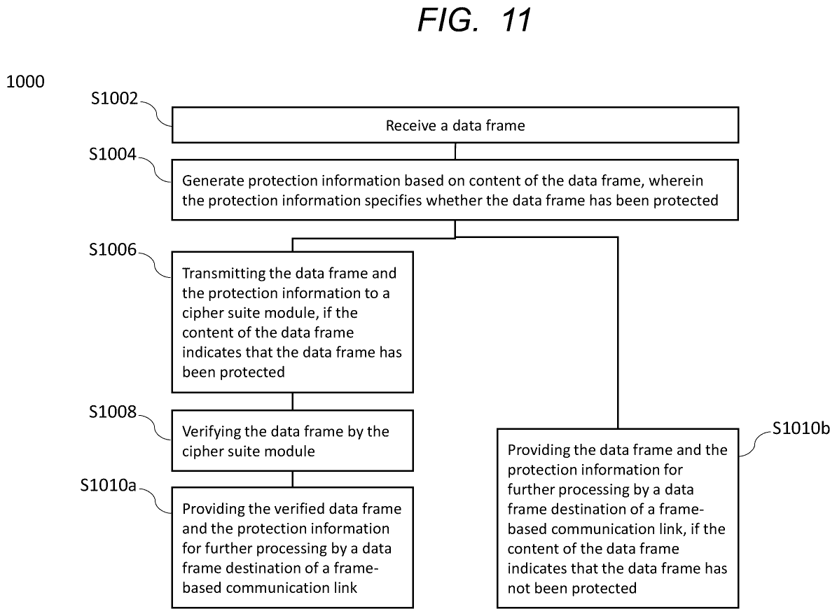

Further, a method 1000 is provided for verifying a data frame for a frame-based communication link as depicted in the flowchart of FIG. 11. In addition to the following method steps, method 500 may optionally include all variations described above with respect to apparatus 500, 602, 700 and 801 that have been described in connection with FIGS. 6 to 9.

In Step S1002, a data frame is received.

In step S1004, protection information is generated based on content of the data frame, wherein the protection information specifies whether the data frame has been protected. If the frame-based communication link uses multiple SCs, the protection information may additionally specify an SC of a data frame that has been protected.

In step S1006, the data frame and the protection information are transmitted to a cipher suite module, if the content of the data frame indicates that the data frame has been protected.

In step S1008, the data frame is verified by the cipher suite module.

In step S1010a, the verified data frame and the protection information are provided for further processing by a data frame destination of a frame-based communication link.

Alternatively, in step S1010b, the data frame and the protection information are directly provided for further processing by a data frame destination of a frame-based communication link (i.e., omitting steps S1006 and S1008, if the content of the data frame indicates that the data frame has not been protected.

### Specific Implementations

In the following, two particular implementations of the embodiments of this disclosure will be briefly described. These implementations should however not be understood as limiting the subject-matter of this disclosure.

First, an implementation in a Renesas ethernet switch (RSwitch2) will be described. If the protection information is implemented in the MAC as a side-band signal, 4 bit may be needed at the receiver (11 possible values, i.e., controlled/uncontrolled and verification error types) and 1 bit may be needed at the transmitter side (2 possible values, i.e., controlled/uncontrolled). Further, 4 bit may be additionally needed for specifying the SC, if multiple SCs are supported.

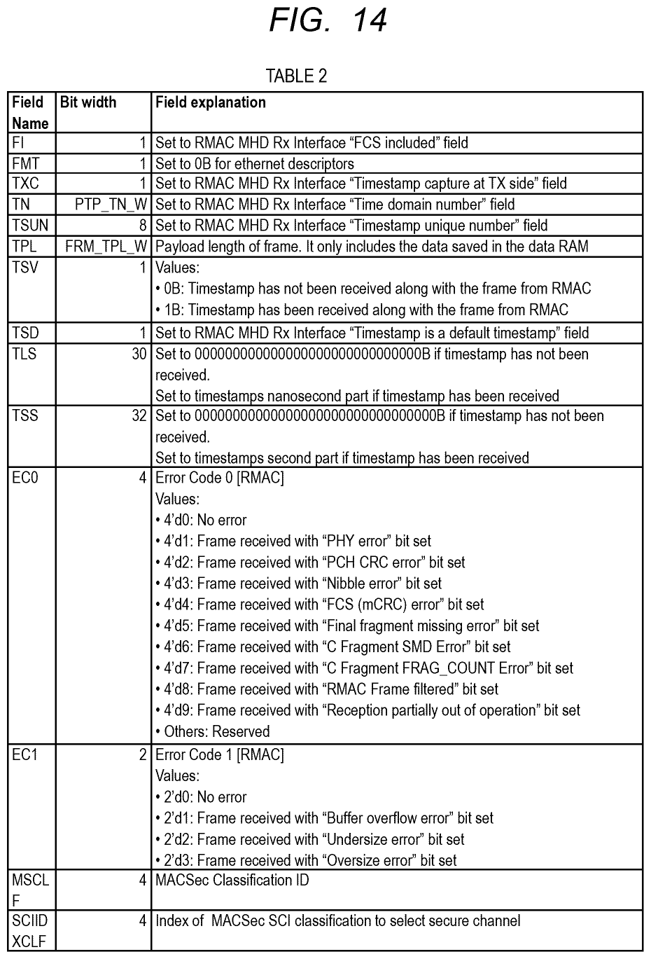

Alternatively, the protection information may be transported as an in-band signal, i.e., attached to the data frame. In FIG. 14, Table 2 lists a format according to the internal descriptor format of the RSwitch2. The additional values needed due the protection information are highlighted in grey in Table 2.

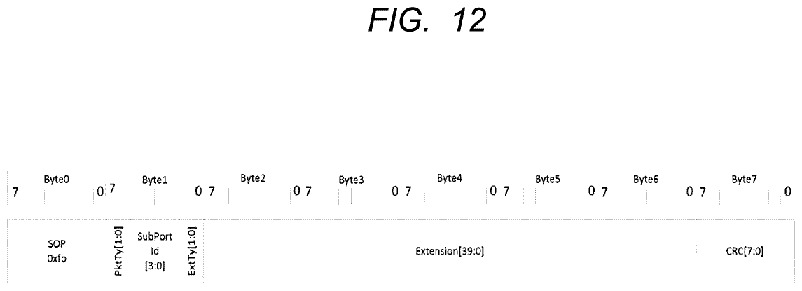

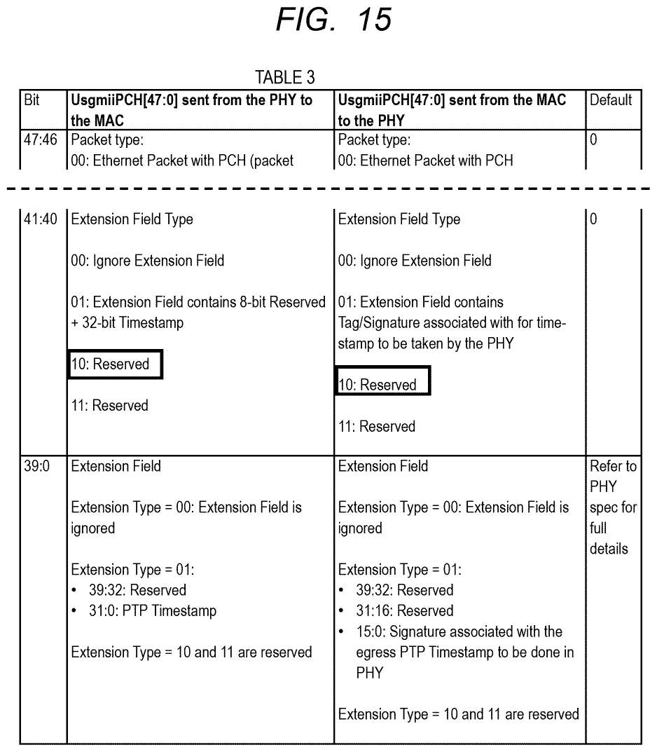

Next, a PHY implementation is briefly described with respect to USXGMII (“Universal SXGMII Interface for a Single MultiGigabit Copper Network Port” by Cisco Systems, Document ID: USXGMII-Copper PHY: EDCS-1150953). For a PHY implementation, the protection information may be transported as an in-band signal, i.e., attached to the data frame. FIG. 12 depicts a Packet Control Header (PCH) format according to USXGMII. The PCH format already provides an extension field. Therefore, the extension field may be used to encode the protection information. The extension field leaves 8bit reserved in each direction (i.e., PHY to MAC and MAC to PHY). Therefore, in each direction, 4 bit may be used for transporting the controlled/uncontrolled information and verification error type information (PHY to MAC only). The remaining 4 bits may be used to specify the used SC. In FIG. 15, Table 3 shows an example USXGMII PCH format extended by the MACSec classifer. In this example implementation, extension field type 10 (marked in grey) shall be used for the MACSec classification (protection information) and a timestamp format.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### Interpretation

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present invention, various features of the present invention are sometimes grouped together in a single example embodiment, Fig., or description thereof for the purpose of streamlining the present invention and aiding in the understanding of one or more of the various inventive aspects. This method of invention, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this invention.

Furthermore, while some example embodiments described herein include some but not other features included in other example embodiments, combinations of features of different example embodiments are meant to be within the scope of the present invention, and form different example embodiments, as would be understood by those skilled in the art. For example, in the following claims, any of the claimed example embodiments can be used in any combination.

In the description provided herein, numerous specific details are set forth. However, it is understood that example embodiments of the present invention may be practiced without these specific details. In other instances, well-known methods, structures and techniques have not been shown in detail in order not to obscure an understanding of this description.

Thus, while there has been described what are believed to be the best modes of the present invention, those skilled in the art will recognize that other and further modifications may be made thereto without departing from the spirit of the present invention, and it is intended to claim all such changes and modifications as fall within the scope of the present invention. For example, any formulas given above are merely representative of procedures that may be used. Functionality may be added or deleted from the block diagrams and operations may be interchanged among functional blocks. Steps may be added or deleted to methods described within the scope of the present disclosure.

1. An apparatus for protecting a data frame for a frame-based communication link, the apparatus comprising:
a receiver module, a cipher suite module and a transmitter module;
wherein the receiver module is configured to receive the data frame and protection information for the data frame, wherein the protection information specifies whether the data frame is to be protected;
wherein the receiver module is further configured to transmit the data frame to the cipher suite module, if the protection information specifies that the data frame is to be protected;
or the receiver module is further configured to transmit the data frame to the transmitter module, if the protection information specifies that the data frame is not to be protected;
wherein the cipher suite module is configured to protect the data frame and transmit the protected data frame to the transmit module; and
wherein the transmit module is configured to provide the data frame or the protected data frame for transmission over the frame-based communication link.

2. The apparatus according to claim 1,
wherein the protection information is comprised by the data frame or the protection information is transmitted on a side-band signal.

3. The apparatus according to claim 1,
wherein the protection information indicates a source configuration of the data frame.

4. The apparatus according to claim 3,
wherein the source configuration of the data frame is any one of a direct memory access controller, DMAC, channel, a channel configuration of a DMAC channel, and a forwarding configuration.

5. The apparatus according to claim 1,
wherein the protection information further specifies a security channel, SC, associated with the data frame, if the protection information specifies that the data frame is to be protected;
wherein the receiver module is further configured to transmit the protection information to the cipher suite module; and
wherein protecting the data frame is based on the SC.

6. The apparatus according to claim 1,
wherein the frame-based communication link is an Ethernet communication link and the apparatus is a Media Access Control Security, MACsec apparatus of a transmission Ethernet side; and
wherein the data frame is an Ethernet data frame.

7. A transmission side device of a frame-based communication link, the transmission side device comprising:
an apparatus for protecting data frames according to claim 3; and
a data frame source, wherein the data frame source is configured to provide the data frame to the apparatus based on the source configuration of the data frame, to generate the protection information based on the source configuration of the data frame, and to provide the protection information to the apparatus.

8. The transmission side device according to claim 7,
wherein the transmission side device is a client device and the data frame source is a frame generation software stack of the client device, or the transmission side device is a network switch and the data frame source is a forwarding module in the network switch.

9. An apparatus for verifying a data frame for a frame-based communication link, the apparatus comprising:
a receiver module, a cipher suite module and a transmitter module;
wherein the receiver module is configured to receive the data frame and to generate protection information based on content of the data frame, wherein the protection information specifies whether the data frame has been protected;
wherein the receiver module is further configured to transmit the data frame and the protection information to the cipher suite module, if the content of the data frame indicates that the data frame has been protected;
or the receiver module is further configured to transmit the data frame and the protection information to the transmitter module, if the content of the data frame indicates that the data frame has not been protected;
wherein the cipher suite module is configured to verify the data frame and to transmit the verified data frame and the protection information to the transmit module;
wherein the transmit module is configured to provide the protection information and the data frame or the verified data frame for further processing by a data frame destination of the frame-based communication link.

10. The apparatus according to claim 9,
wherein the protection information is comprised by the data frame or the protection information is transmitted on a side-band signal.

11. The apparatus according to claim 9,
wherein the protection information indicates a destination configuration of the data frame.

12. The apparatus according to claim 11,
wherein the destination configuration of the data frame is any one of a direct memory access controller, DMAC, channel, a channel configuration of a DMAC channel, and a forwarding configuration.

13. The apparatus according to claim 9,
wherein the cipher suite module is further configured to determine a type of validation error, if the verifying of the data frame returns a negative result;
the cipher suite module is further configured to add the type of validation error to the protection information and to transmit the protection information and the negatively verified data frame to the transmission module; and
the transmission module is further configured to provide the negatively verified data frame and the protection information for further processing by the data frame destination of the frame-based communication link.

14. The apparatus according to claim 7,
wherein the protection information further comprises a security channel, SC, associated with the data frame, if the protection information specifies that the data frame is to be protected, and the receiving module is configured to determine the SC based on a header of the data frame; and
wherein verifying the data frame is based on the SC.

15. The apparatus according to claim 9,
wherein the frame-based communication link is an Ethernet communication link and the apparatus is a Media Access Control Security, MACsec apparatus of a receiving Ethernet side; and
wherein the data frame is an Ethernet data frame.

16. The apparatus according to claim 15,
wherein the data frame is received from an Ethernet MAC module, and wherein the apparatus comprises the Ethernet MAC module or the Ethernet MAC module is connected to the apparatus.

17. A receiving side device of a frame-based communication link, the receiving side device comprising:
an apparatus for verifying the data frame according to claim 11; and
the data frame destination, wherein the data frame destination is configured to receive the data frame from the apparatus and to process the data frame based on the protection information.

18. The receiving side device according to claim 17,
wherein the receiving side device is a client device and the data frame destination is a frame receiving software stack of the client device or the receiving side device is a network switch and the data frame destination is a forwarding module in the network switch.

19. The receiving side device according to claim 17,
wherein the further processing by the data frame destination comprises a validation error analysis based on the type of the validation error, if the data frame is a negatively verified data frame.

20. A method of performing protection of a data frame with an apparatus according to claim 1.
